(19) United States
(12) Patent Application Publication
(10) Pub. No.: US 2017/0020117 A1
(43) Pub. Date: Jan. 26, 2017

(54) FISHING LURE WITH A SCOOPED HEAD AND ANGLED BODY

(71) Applicant: George P. Korteweg, Mystic, CT (US)

(72) Inventor: George P. Korteweg, Mystic, CT (US)

(21) Appl. No.: 14/803,438

(22) Filed: Jul. 20, 2015

(51) Int. Cl. A01K 85/02; A01K 85/16; A01K 85/00

(52) U.S. Cl. CPC A01K 85/02; A01K 85/00; A01K 85/16

(57) ABSTRACT

A fishing lure including a head and an angled body is provided. The head includes an upper surface and a lower surface. An indent or scoop is formed on the upper surface of the head. The body is attached to the head at a bend forming an angle relative to the head. The angle is between about 5° and about 30°. The indent varies in different depths, lengths and angles, which effect the unique movement of each lure. Further, the angled head and body causes the head to move back and forth through the water as the lure is being reeled, which in turn causes the tail to wag.

### BACKGROUND OF THE INVENTION

The present invention relates to fishing lures and, more particularly, to a fishing lure with an angled body.

A fishing lure is a type of artificial fishing bait which is designed to attract a fish's attention. To do this, the lure uses movement, vibration, flash and color. Many lures are equipped with one or more hooks that are used to catch fish when they strike the lure. Most lures are attached to the end of a fishing line and have various styles of hooks attached to the body and are designed to elicit a strike resulting in a hook up.

When using an artificial lure, most of the designs require the lure to be jerked or twitched by the user during the course or reeling the lure to cause the lure to appear more natural to live fish. As a result, the lure speeds up and slows down through the water, which is unnatural to a slow-moving or feeding eel or fish. Current manufactured lures of this type fail to mimic live natural movements and action.

As can be seen, there is a need for a lure that mimics live natural movements and actions of fish.

### SUMMARY OF THE INVENTION

In one aspect of the present invention, a fishing lure comprises: a head comprising an upper surface and a lower surface, wherein a scoop is formed on the upper surface; and a body attached to the head at a bend forming an angle relative to the head for additional movement.

These and other features, aspects and advantages of the present invention will become better understood with reference to the following drawings, description and claims.

### BRIEF DESCRIPTION OF THE DRAWINGS

FIG. 1A is a perspective view of a lure with a modified “J Hook” constructed in accordance with the present invention.

FIG. 1B is a perspective view of a lure without the modified “J Hook” constructed in accordance with the present invention.

FIG. 2 is a top view of the head-scoop with the different hook eye hole variations;

FIG. 3A is a side view of the eel-type lure showing a 23 degree angle as well as the modified “J Hook” through the hook-holding knobs;

FIG. 3B is a side view of a lure showing an 18 degree angle, the head-scoop and the modified “J Hook” rigged through the knobs and up through the head-scoop;

FIG. 4 is a side view of the convoluted-type lure showing a 28 degree angle with the hook attachment knobs on the bottom of the lure;

FIG. 5A is a side view of the eel or snake-type lure with the head-scoop attached to the molded tubing, angle body, and modified “J Hook”; and

FIG. 5B is a side view of smaller eel or snake-type lure with the head scoop attached to the molded tubing and hook knobs without the “J Hook” attached.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a fishing lure with a scooped head and an angled body. The lures of the present invention are designed to replicate the same movement of an eel or a fish swimming through water, thereby alleviating the user from having to jerk the lure while reeling. Once the lure is attached to the fishing lure and cast, the user may reel at any speed, creating the natural movement of an eel or fish.

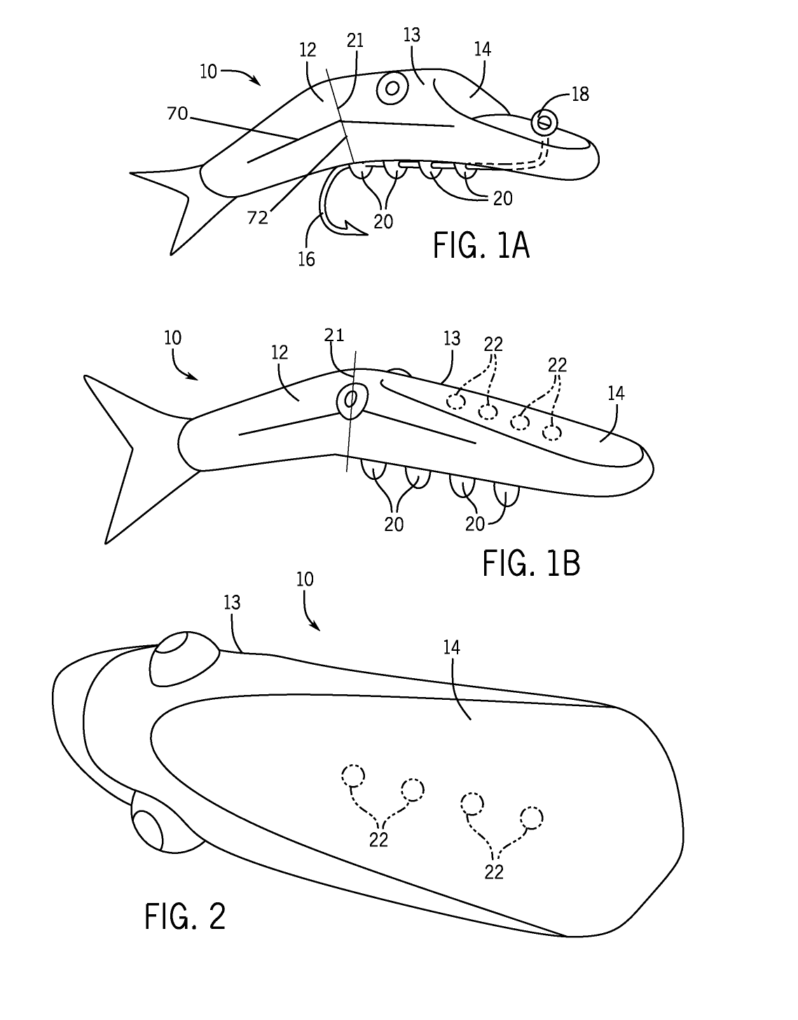

Referring to FIGS. 1 through 5, the present invention includes a fishing lure 10 including a head 13 and a body 12. The head 13 includes an upper surface and a lower surface. An indent 14 or scoop is formed on the upper surface of the head 13. The body 12 is attached to the head 13 at a bend forming an angle 21 relative to the head 13. The angle may be between about 5° and about 30°. The indent 14 varies in different depths, lengths and angles, which effect the unique movement of each lure 10. Further, the angled head 13 and body 12 causes the head 13 to move back and forth through the water as the lure 10 is being reeled, which in turn causes the body 12 to wag.

The lure 10 of the present invention may include a fishing hook 16. The fishing hook 16 includes a hook portion and an eyelet 18 opposite the hook portion. The fishing hook 16 runs thorough the head 13 so that the eyelet 18 is disposed within the indent 14 and the hook portion is protruding from the lower surface. The lure 10 of the present invention includes a tunnel 70 running through a center portion of the head 13 and through the center of the body 12, which allows a hook to be placed in the rear of the lure 10 as well as a weight to placed within the lure 10. The tunnel 70 may have about a 3 mm diameter. A weight with up to a 10 mm diameter fits within the tunnel 70. An entrance 72 to the tunnel 70 may be formed at the bend connecting the head 34 and the body 32. The entrance 72 may run from an outer surface of the lure 10 to the internal tunnel 70.

The J hook 16 of the present invention may include a first bend forming the hook portion and a second bend formed in the opposite direction as the hook portion. The eyelet 18 is formed beyond the second bend. The second bend is up to about 90° to a body portion of the hook 16 and about 180° relative to the hook portion of the hook 16. The second bend allows the eyelet 18 to protrude from holes preformed in the indent 14.

The present invention may include at least one knob 20 formed on a lower surface of the head 14. The hook 16 runs through the at least one knob 20 and secures the hook 16 to the lure 10. In certain embodiments, the present invention may include a plurality of knobs 20. The knobs 20 provide hook stability, and the ability to run the hook 16 outside of the lure 10.

In certain embodiments, the tip of the head 14 slopes towards the bottom surface. The indent 14 is formed in the tip. The indent 14 of the lure 10 may be designed with a set of prefabricated holes 22 which allows the user to place the hook 16 in different positions, which in turn causes different action and motion in the water.

The lure 10 of the present invention may be made of a stretchable material, such as a stretchable polymer. The present invention may be made as one unit using a plastic, such as thermoplastics, poured into or injected into a mold. Alternatively, the head 10 may be formed separately from the body 12 and may be secured together by an adhesive. Further, a pie slice shape may be cut from an existing lure and the two exposed ends may be fused back together to form the angled lure 10. The lure material may include a 10-1 stretch modulus and the material does not have directional tear. Therefore, old hooks 16 may be easily removed and replaced with new hooks 16 through the same knobs without tearing or breaking the lure 10.

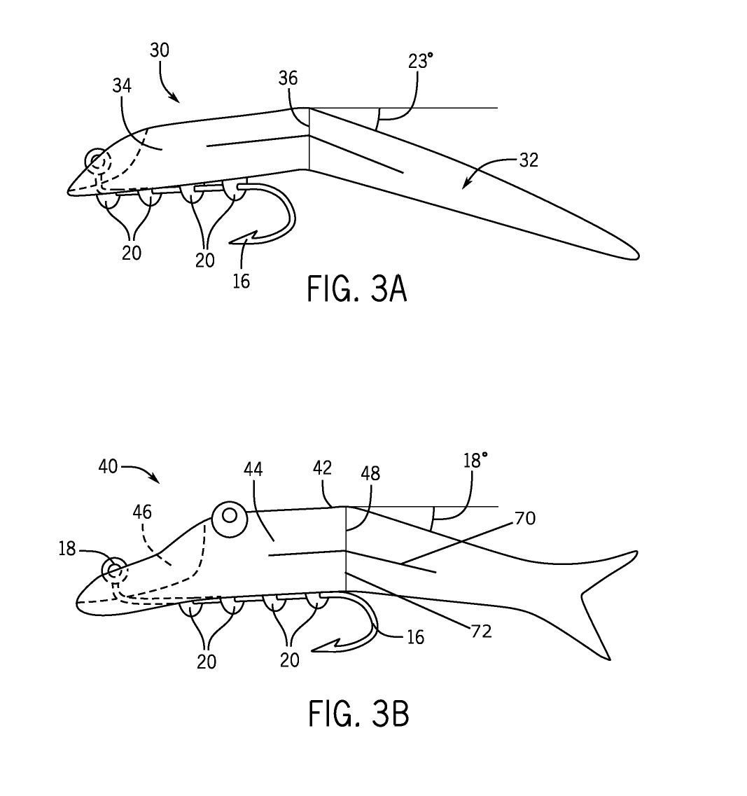

Referring to FIG. 3A, the present invention may include a lure 30 shaped like an eel. The lure 30 includes a head 34 and a body 32. The head 34 and the body 32 are joined at a bend. The bend may be at an angle 36 of 23°.

Referring to FIG. 3B, the present invention may include a lure 40 shaped like a fish. The lure 40 includes a head 44 and a body 42. The head 44 may include an indent 46 with an alternate shape and size. The head 44 and the body 42 are joined at a bend. The bend may be at an angle 48 of 18°.

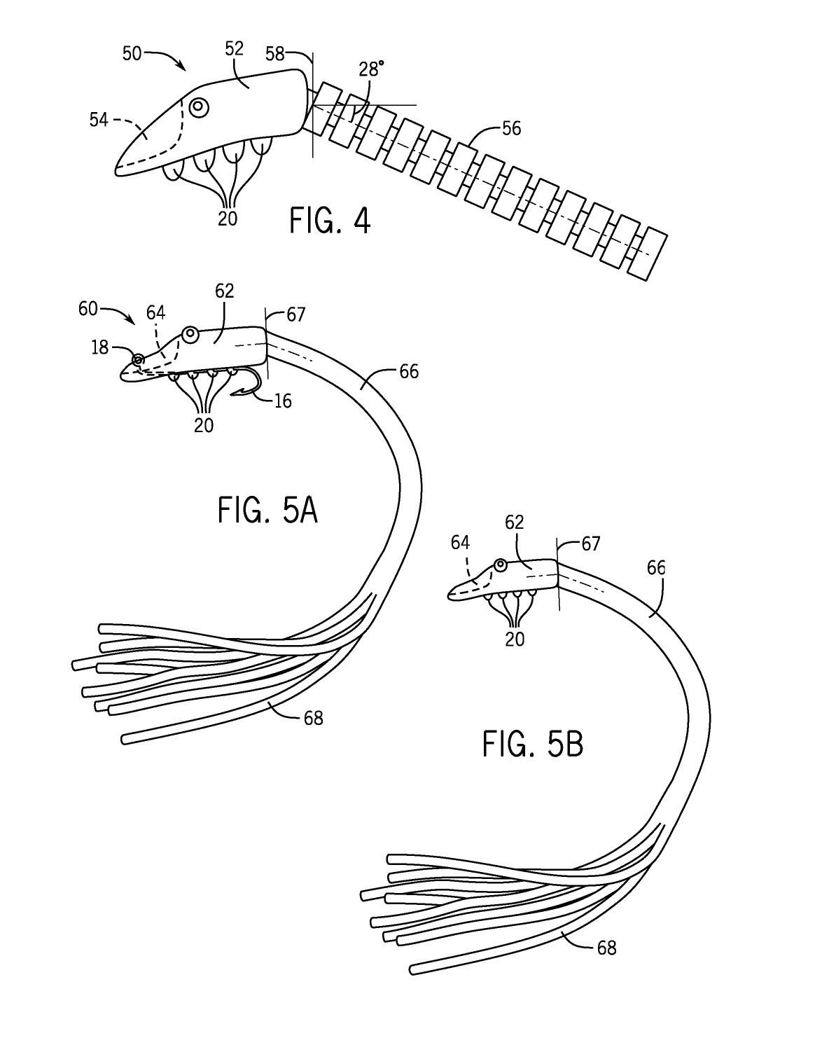

Referring to FIG. 4, the present invention may include a lure 50 shaped like an eel or worm. The lure 50 includes a head 52 and a segmented tail 56. The segmented tail 56 may allow additional side to side movement. The head 52 may include an indent 54 with an alternate shape and size. The head 52 and the tail 56 are joined at a bend. The bend may be at an angle 58 of 28°.

Referring to FIG. 5A and FIG. 5B, the present invention may include a lure 60 shaped like an eel or worm. The lure 60 includes a head 62 and a tail 66 formed of a tubing with a plurality of filaments 68 may be formed at the end. The head 62 may include an indent 64 with an alternate shape and size. The head 62 and the tail 66 are joined at a bend having an angle 67.

It should be understood, of course, that the foregoing relates to exemplary embodiments of the invention and that modifications may be made without departing from the spirit and scope of the invention as set forth in the following claims.

What is claimed is:

1. A fishing lure comprising:
a head comprising an upper surface and a lower surface, wherein an indent is formed in the upper surface; and
a body attached to the head at a bend forming an angle relative to the head.

2. The fishing lure of claim 1, further comprising a fishing hook comprising a hook portion and an eyelet portion, wherein the fishing hook runs thorough the head so that the eyelet is disposed within the indent and the hook portion is protruding from the lower surface.

3. The fishing lure of claim 2, wherein the fishing hook comprises a first bend forming the hook portion a second bend formed in the opposite direction as the hook portion, wherein the eyelet is formed beyond the second bend.

4. The fishing lure of claim 3, wherein the second bend is up to about 90°.

5. The fishing lure of claim 2, further comprising at least one knob formed on a lower surface of the head, wherein the hook runs through the at least one knob.

6. The fishing lure of claim 5, wherein the at least one knob is a plurality of knobs.

7. The fishing lure of claim 1, wherein the angle is between about 5° and about 30°.

8. The fishing lure of claim 7, wherein the angle is between about 18° and about 28°.

9. The fishing lure of claim 8, wherein the angle is about 23°.

10. The fishing lure of claim 1, wherein a tip of the head slopes towards the bottom surface, wherein the indent is formed in the tip.
